(19) United States
(12) Patent Application Publication
(10) Pub. No.: US 2012/0317592 A1
(43) Pub. Date: Dec. 13, 2012

(54) METHOD AND SYSTEM FOR PROVIDING ADDITIONAL INFORMATION OF CONTENTS

(75) Inventors: Jae-Won Kim, Suwon-si (KR); Woo-Jin Park, Yongin-si (KR)

(73) Assignee: SAMSUNG ELECTRONICS CO., LTD., Suwon-si (KR)

(21) Appl. No.: 13/492,722

(22) Filed: Jun. 8, 2012

(30) Foreign Application Priority Data
Jun. 9, 2011 (KR) 10-2011-0055703

(51) Int. Cl. H04N 21/43; H04N 21/24

(52) U.S. Cl. 725/14; 725/37

(57) ABSTRACT

A method and system for providing additional information of contents to enhance quality for selecting contents by sharing previous information about the contents with one another is provided. The method comprises capturing an image of the contents and a previously defined action of a user and transmitting the capture images to a contents sever at at least one or more terminals, when the previously defined action of the user is detected while receiving the corresponding contents from the contents server and reproducing the received contents and including the capture images received from the at least one or more terminals in the additional information of the corresponding contents at the contents server.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Jun. 9, 2011 and assigned Serial No. 10-2011-0055703, the entire disclosure of which is hereby incorporated by reference.

### TECHNICAL FIELD OF THE INVENTION

The present disclosure relates to a method and system for providing additional information about contents to a user.

### BACKGROUND OF THE INVENTION

Electronic devices such as mobile terminals, personal complex terminals, and digital TVs. have become necessities of current society based on development of electronic communication industries. The electronic devices have developed into important means of information transmission, which are quickly changed. As everyone knows, the trend in the electronic devices is toward intelligent electronic devices having computer supporting functions such as an Internet communication function and an information search function. These intelligent electronic devices may also be found easily in home. Recently, these electronic devices (e.g., a smart phone, a smart TV, etc.) interact by wire or wireless to implement a home network.

A user may receive a variety of contents through these electronic devices. The contents are a variety of information provided through Internet, computer communication, etc. and have an electronic commerce type capable of being purchased, paid, and used through a network and a terminal. Market demand for the contents is expanding.

In general, users may post comment on contents and a postscript to use of the contents. This helps to allow other users to select the contents. However, it is difficult for children who do not express themselves clearly to post comment on contents and a postscript to use of the contents. In general, adults (e.g., parents, teachers, etc.) who cover for children post comment on contents. That is just thoughts of the adults who cover for the children. Furthermore, it is difficult for adults to select contents for children in that the adults may not collect opinions which the adults look at from infant's own angle.

### SUMMARY OF THE INVENTION

To address the above-discussed deficiencies of the prior art, it is a primary object to provide at least the advantages described below. Accordingly, an aspect of the present disclosure is to provide a method and system for providing additional information of contents to enhance quality for selecting contents by sharing previous information about the contents with one another.

Another aspect of the present disclosure is to provide a method and system for providing additional information of contents to share the additional information for indicating responses of children with respect to the contents and refer to the additional information when selecting the contents for the children.

Another aspect of the present disclosure is to provide a method and system for providing additional information of contents to allow a contents provider to receive the additional information for indicating responses of children with respect to the contents and reflect the received additional information to making of the contents.

In accordance with the present disclosure, a method of providing additional information of contents is provided. The method comprises capturing an image of the contents and a previously defined action of a user and transmitting the capture images to a contents server by at least one or more terminals, when the previously defined action of the user is detected while receiving the corresponding contents from the contents server and reproducing the received contents; and including the capture images received from the at least one or more terminals in the additional information of the corresponding contents at the contents server.

In accordance with the present disclosure, a system for providing additional information of contents is provided. The system comprises a terminal for capturing an image of the contents and a previously defined action of a user and transmitting the capture images to a contents server when the previously defined action of the user is detected while receiving the corresponding contents and reproducing the received corresponding contents after being connected to the contents server according to input of the user, and the contents server for including the capture images received from the terminal in the additional information of the corresponding contents.

In accordance with the present disclosure, a terminal for receiving contents is provided. The terminal comprises an input unit for receiving input of a user, an output unit for outputting an image data, a storage unit for storing a data, a communication unit for performing communication, a camera unit for photographing motion of the user, and a controller for controlling an overall operation, wherein the controller connects to a contents server through the communication unit according to corresponding input of the user, which is received from the input unit, receives corresponding contents, and outputs the received corresponding contents as an image through the output unit and wherein the controller captures a reproducing image of the contents and a previously defined action of the user and transmits the captured images to the contents server through the communication unit when the previously defined action of the user is detected from a motion image of the user, which is received from the camera unit while outputting the image of the corresponding contents to the output unit.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a contents providing system according to one embodiment of the present disclosure;

FIG. 2 illustrates a structure of a terminal according to one embodiment of the present disclosure;

FIG. 3 illustrates a process of capturing an image included in additional information of corresponding contents according to one embodiment of the present disclosure;

FIG. 4 illustrates a process of verifying additional information of corresponding contents according to one embodiment of the present disclosure;

FIG. 5 illustrates a process of generating additional information about corresponding contents at a contents server according to one embodiment of the present disclosure; and

FIGS. 6A-B illustrate additional information of corresponding contents according to one embodiment of the present disclosure.

### DETAILED DESCRIPTION OF THE INVENTION

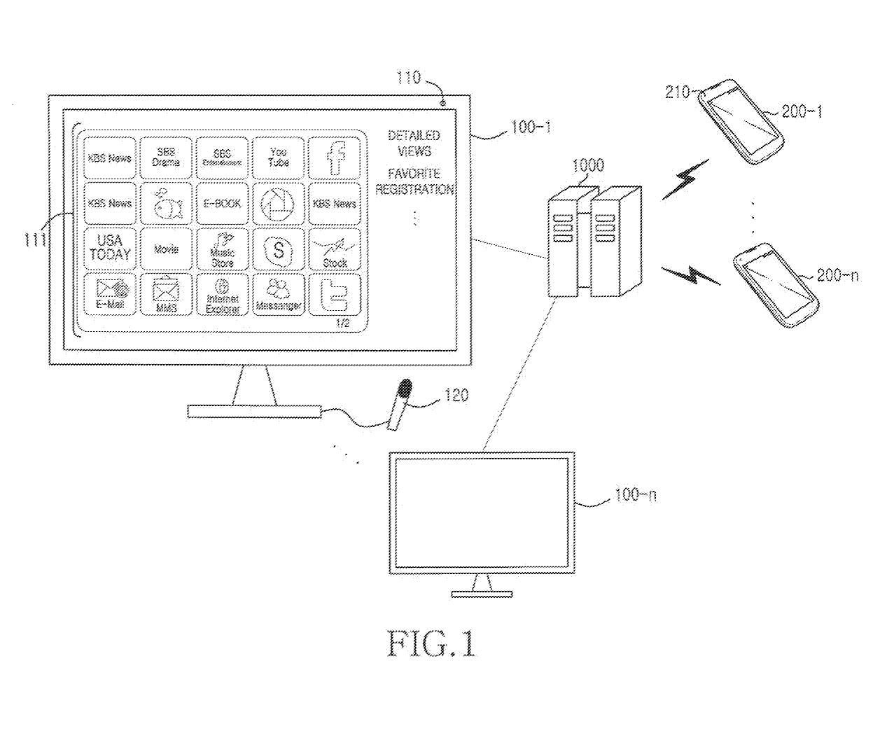

FIGS. 1 through 6B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile device. Exemplary embodiments of the present disclosure will be described herein below with reference to the accompanying drawings. In the following description, well-known functions or constructions are not described in detail since they would obscure the invention in unnecessary detail. Also, the terms used herein are defined according to the functions of the present disclosure. Thus, the terms may vary depending on user's or operator's intension and usage. That is, the terms used herein must be understood based on the descriptions made herein.

The present disclosure relates to a method and system for providing additional information of contents to enhance quality for selecting contents by sharing previous information about the contents with one another.

The present disclosure described hereinafter relates to a method and system for providing contents to a user. More particularly, the present disclosure relates to a method and system for providing contents to enhance quality for selecting contents by sharing previous information about contents with one another. More particularly, the present disclosure shares additional information indicating responses of children with respect to contents and refers to the additional information when selecting or making contents for children. In accordance with one embodiment of the present disclosure, a contents receiving terminal analyzes actions of children, collects additional information indicating responses of the children with respect to these contents, and provides the collected additional information to a corresponding (contents) server.

FIG. 1 illustrates a configuration of a contents providing system according to one embodiment of the present disclosure.

Referring to FIG. 1, the contents providing system according to one embodiment of the present disclosure includes a contents server (hereinafter, referred to as a server) 1000 for providing contents and a plurality of client terminals for performing wire or wireless communication with the server 1000.

The server 1000 stores contents provided from a contents provider and provides the contents to a terminal which requests the contents. As described farther on, each of the terminals generates additional information about contents when a previously defined condition is satisfied and transmits the generated additional information to the server 1000. The server 1000 stores the additional information according to corresponding contents. The server 1000 provides the corresponding additional information to a terminal which requests the additional information about the corresponding contents.

The terminals may be a plurality of smart TVs (100-1, . . . , 100-n), a plurality of smart phones (200-1, . . . , 200-n), a plurality of Personal Computers (PCs), etc. Each of the terminals sets up an interface environment for interworking with the server 1000. If a search is requested by a user, each of the smart TVs (100-1, . . . , 100-n) and each of the smart phones (200-1, . . . , 200-n), that is, each of the terminals connects to the server 1000 and displays a contents list 111 corresponding to a search condition. If the user selects corresponding contents on the contents list 111, each of the terminals receives the selected contents from the server 1000 and reproduces the received contents.

Each of the terminals may analyze an action of the user while reproducing the contents. If a previously defined action of the user is detected, each of the terminals captures an image of the contents and the previously defined action of the user and transmits the capture images to the server 1000. The server 1000 includes the captured images received from each of the terminals in additional information about the reproducing contents. Each of the terminals may capture the previously defined action of the user using the following components. Each of the terminals has a corresponding one of cameras 110 and 210 which monitor actions of the users. Each of the cameras 110 and 210 photographs the motion of the users. Each of the terminals analyzes a motion image of the user provided in real time from a corresponding one of the cameras 110 and 210 and discriminates when the analyzed motion image satisfies the previously defined action of the user. The previously defined action of the user may be facial expressions such as a smiling face, a crying face, and an angry face. Also, each of the terminals may receive information about motion of the user from an external device 120. The external device 120 has an operation detecting sensor. The external device 120 is attached to a body of the user and may sense motion of the user. Each of the terminals may discriminate a previously defined action of the user (e.g., body motion such as motion in which he or she claps his or her hands, motion in which he or she waves his or her hand, and sudden motion) from sensing information provided from the external device 120. This operation detecting sensor may be included in each of the terminals.

As described above, the server 1000 stores a plurality of capture images generated for corresponding contents by a plurality of the terminals according to the contents. In addition, the server 1000 provides corresponding additional information to a terminal which requests the additional information about corresponding contents. Accordingly, a purchaser may verify additional information about contents which he or she wants to purchase in advance and may determine the purchase of the verified contents. This configuration of the present disclosure is specialized for children who have troubles posting postscripts to use of contents. For example, each of a plurality of terminals which are positioned in different places transmits capture images according to actions of a child with respect to “A” contents for the child to the server 1000. The server 1000 includes the capture images in additional information of the “A” contents for infant. When any parent wants to know that the “A” contents for the child are suitable for his or her child, he or she may verify capture images included in the additional information. The parent may verify an image when his or her child smiles, an image when his or her child cries, etc. The parent may discriminate whether the “A” contents for the child are suitable for his or her child in advance with reference to the verified images. For example, if the parent verifies an image in which his or her child who sees a disgusting animal image and cries is captured, he or she avoids purchasing the contents for infant.

In addition, additional information of these contents may also be useful to a contents provider. For example, the contents provider looks forward to a smile of a child from an image of a corresponding frame. However, contrary to expectations, if the smile of the child is not verified from the image of the corresponding frame, the contents providers will consider correction of contents. For another example, if a capture image in which the contents provider does not think a child cries is verified, he or she will consider correction of contents. For another example, the contents provider expects a child to follow clapping from a capture image which induces the child to follow the clapping. However, contrary to expectations, if it is not verified that the child claps his or her hands from the corresponding capture image, the contents provider will consider correction of contents.

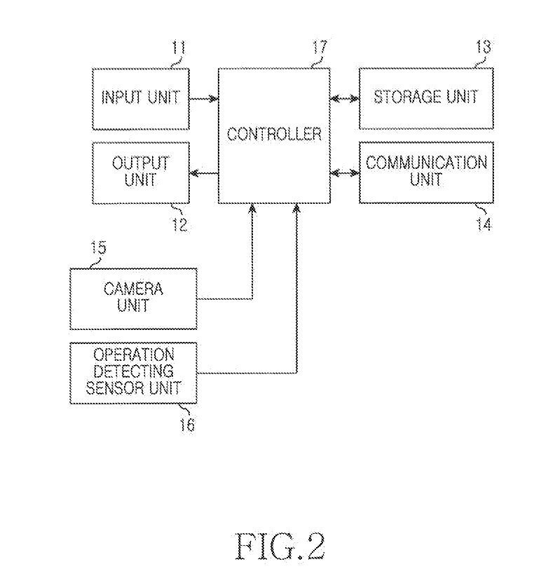

FIG. 2 illustrates a structure of a terminal according to one embodiment of the present disclosure.

Referring to FIG. 2, the terminal according to one embodiment of the present disclosure includes an input unit 11 for receiving input of a user, an output unit 12 for outputting an image data, a storage unit 13 for storing a data, a communication unit 14 for performing communication, a camera unit 15 for monitoring the user, an operation detecting sensor unit 16 for sensing motion of the user, and a controller 17 for controlling an overall operation.

A touch sensitive display, called as a touch screen, may be used as the output unit 12. In this situation, touch input may be performed via the touch sensitive display.

The controller 17 connects to a server through a communication unit 14 according to corresponding input of the user, which is received from the input unit 11. The controller 17 receives corresponding contents and outputs an image and a voice through the output unit 12.

Particularly, the camera unit 15 photographs motion of the user while images of the corresponding contents are output, and outputs the photographed images to the controller 17. The controller 17 analyzes a motion image of the user, which is received from the camera unit 15, and discriminates when the analyzed motion image satisfies a previously defined action of the user. If the previously defined action of the user is detected, the controller 17 captures a reproducing image of the contents and the previously defined action of the user and transmits the captured image to the server through the communication unit 14. In addition, the operation detecting sensor unit 16 senses motion of the user and informs the sensed information to the controller 17. The controller 17 discriminates when the previously defined action is satisfied from the information received from the operation detecting sensor unit 16. If a previously defined action of the user is detected, the controller 17 captures a reproducing image of the contents and the detected previously defined action of the user and transmits the captured image to the server through the communication unit 14. As described above, the contents server includes a capture image received from the smart TV in additional information of corresponding contents. The capture image indicates the corresponding contents and may include header information including captured time, etc.

In addition, the controller 17 connects to the server through the communication unit 14 according to input of the user, which is received from the input unit 11. The controller 17 receives the additional information of the corresponding contents and may display the received additional information. The additional information includes capture images received from a plurality of terminals.

The storage unit 13 stores interface environments for controlling an overall operation of the terminal and a variety of data items input and output when a control operation of the terminal is performed.

The controller 17 controls an overall operation of the terminal. Hereinafter, a method for providing contents at the controller 17 according to one embodiment of the present disclosure will be described with reference to drawings.

The method described hereunder of the present invention may be provided as one or more instructions in one or more software modules stored in the storage unit. The software modules may be executed by the controller 17.

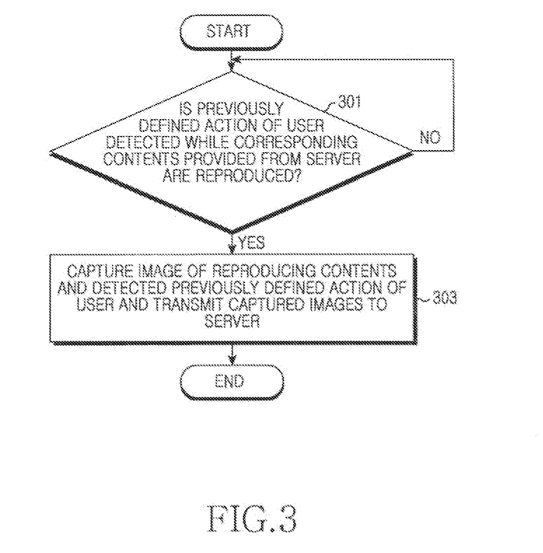

FIG. 3 illustrates a process of capturing an image included in additional information about corresponding contents according to one embodiment of the present disclosure.

Referring to FIG. 2 and FIG. 3, the controller 17 verifies whether a previously defined action of a user is detected through the camera unit 15 or the operation detecting sensor unit 16 while reproducing corresponding contents provided from a server (step 301).

If the previously define action of the user is detected, the controller 17 captures a reproducing image of the contents and the detected previously defined action of the user and transmits the captured image to the server (step 303).

The method performed according to FIG. 3 may be provided as one or more instructions in one or more software modules stored in the storage unit. In that case, the software modules may be executed by the controller 17.

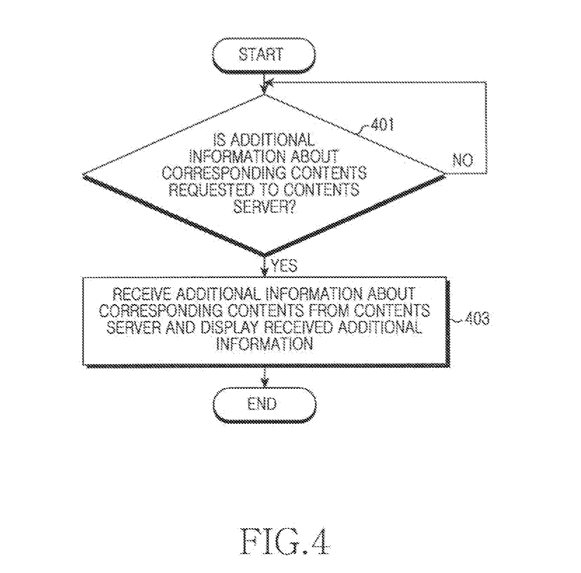

FIG. 4 illustrates a process of verifying additional information of corresponding contents according to one embodiment of the present disclosure.

Referring to FIG. 2 and FIG. 4, the controller 17 verifies whether requesting a server to transmit additional information about corresponding contents (step 401).

The controller 17 receives the additional information about the corresponding contents from the server and displays the received additional information (step 403).

The method performed according to FIG. 4 may be provided as one or more instructions in one or more software modules stored in the storage unit. In that case, the software modules may be executed by the controller 17.

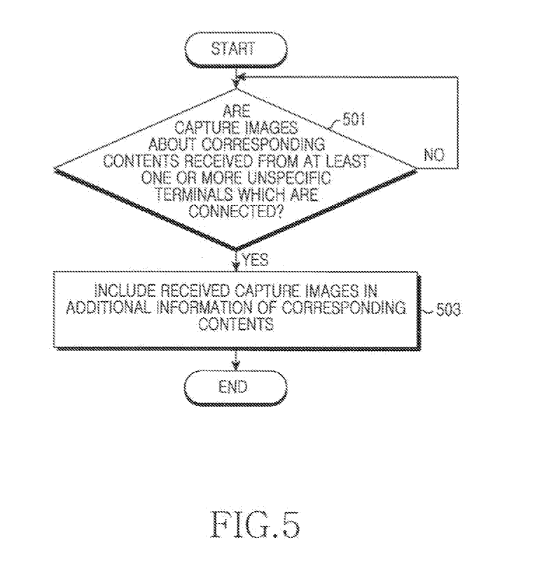

FIG. 5 illustrates a process of generating additional information about corresponding contents at a contents server according to one embodiment of the present disclosure.

Referring to FIG. 5, if capture images about corresponding contents are received from at least one or more unspecific terminals which are connected to the contents server (step 501), the contents server includes the received capture images in additional information about the corresponding contents (step 503). As described above, these capture images indicate the corresponding contents and may include header information including captured time.

Although it is not shown in FIG. 5, if additional information about corresponding contents is requested from a counterpart terminal or a contents provider, the contents server provides the corresponding additional information to the counterpart terminal or the contents provider.

The method performed according to FIG. 5 may be provided as one or more instructions in one or more software modules stored in the storage unit. In that case, the software modules may be executed by the controller 17.

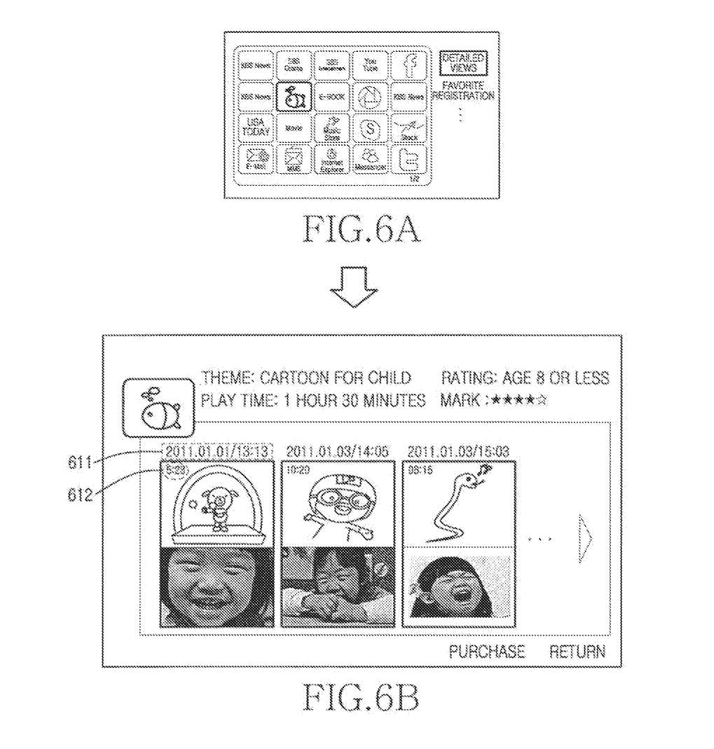

FIGS. 6A-B illustrates additional information of corresponding contents according to one embodiment of the present disclosure.

Referring to FIG. 6A, a user selects detailed views for corresponding contents on a plurality of searched contents list pictures (see FIG. 6A). A terminal receives additional information about the contents in which the detailed views are selected from a contents server and displays the received additional information (see FIG. 6B).

As shown in FIGS. 6A-B, the additional information of the corresponding contents shows a theme, a rating, a play time, a mark, etc. In addition, in accordance with one embodiment of the present disclosure, the additional information shows capture images collected for the contents from a plurality of terminals. The capture images include an image in which a previously defined action of the user is photographed and a contents image captured in time when the previously defined action of the user is detected. As described above, the previously defined action of the user may include a smiling face, a crying face, etc. Each of the capture images includes a generated date and time 611 and a capture time point 612 of a contents image. As described above. A purchaser may determine whether purchasing corresponding contents with reference to these capture images. In addition, although not shown in FIGS. 6A-B, a contents provider may also reflect these capture images to making of corresponding contents.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

In conclusion, a method and system for providing additional information of contents according to one embodiment of the present disclosure allows a user to select contents or allows a contents provider to make contents with reference to the additional information showing actions of an infant.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. A method of providing additional information of contents, the method comprising:
capturing an image of the contents and a previously defined action of a user; and
transmitting the captured images to a contents sever by at least one or more terminals, when the previously defined action of the user is detected while receiving the contents from a contents server and reproducing the received contents, wherein the captured images are included in the additional information of the contents at the contents server.

2. The method of claim 1, wherein the additional information is provided at the contents server when one of a corresponding terminal and a contents provider requests the contents server to transmit the additional information of the contents.

3. The method of claim 1, wherein the captured images indicate the corresponding contents and include header information including a capture time.

4. The method of claim 1, wherein detection of the previously defined action of the user at the at least one or more terminals while receiving the contents from the contents server and reproducing the received contents comprises:
photographing a motion of the user at a camera; and
detecting the previously defined action of the user from the photographed motion.

5. The method of claim 1, wherein detection of the previously defined action of the user at the at least one or more terminals while receiving the contents from the contents server and reproducing the received contents comprises:
sensing information about motion of the user at an operation detecting sensor; and
detecting the previously defined action of the user from the sensed information.

6. The method of claim 1, wherein the previously defined action of the user includes at least one or more facial expressions.

7. The method of claim 1, wherein the previously defined action of the user includes at least one or more body motion.

8. A system for providing additional information of contents, the system comprising:
a terminal configured to capture an image of the contents and a previously defined action of a user and transmit the captured image to a contents server when the previously defined action of the user is detected while receiving the contents and reproducing the received contents after being connected to the contents server according to input of the user; and
the contents server configured to include the captured image received from the terminal in the additional information of the contents.

9. The system of claim 8, wherein the contents server is further configured to provide the additional information when one of the terminal and a contents provider requests the additional information of the contents.

10. The system of claim 8, wherein the captured images indicate the contents and include header information including a capture time.

11. The system of claim 8, wherein the terminal is further configured to detect the previously defined action of the user from an image for motion of the user, which is photographed by one of a camera included in the terminal and a camera connected with the terminal.

12. The system of claim 8, wherein the terminal is further configured to detect the previously defined action of the user from information about motion of the user, which is sensed by an operation detecting sensor included in one of the terminal and an operation detecting sensor connected with the terminal.

13. The system of claim 8, wherein the previously defined action of the user includes at least one or more facial expressions.

14. The system of claim 8, wherein the previously defined action of the user includes at least one or more body motion.

15. A terminal for receiving contents, the terminal comprising:
an input unit configured to receive an input of a user
an output unit configured to output image data;
a storage unit configured to store data;
a communication unit configured to perform communication;
a camera unit configured to photograph motion of the user; and
a controller configured to control an overall operation of the terminal, wherein the controller is configured to:
connect to a contents server through the communication unit according to a corresponding input of the user, which is received from the input unit,
receive the contents, and
output the received contents as an image through the output unit and wherein the controller is configured to capture a reproducing image of the contents and a previously defined action of the user and transmit the captured reproducing image to the contents server through the communication unit when the previously defined action of the user is detected from a motion image of the user, which is received from the camera unit while outputting the captured reproducing image of the contents to the output unit.

16. The terminal of claim 15 further comprising:
an operation detecting sensor unit configured to sense motion of the user, wherein the controller is further configured to capture the reproducing image of the contents and the detected previously defined action of the user and transmit the captured reproducing images to the contents server through the communication unit when the previously defined action of the user is detected from information about the motion of the user, which is received from the operation detecting sensor unit.

17. The terminal of claim 15, wherein the terminal is further configured to communicate with an external device configured to sense motion of the user and wherein the controller is further configured to capture the reproducing image of the contents and the previously defined action of the user and transmit the captured reproducing images to the contents server through the communication unit when the previously defined action of the user is detected from information about the motion of the user, which is received from the external device.

18. The terminal of claim 15, wherein the previously defined action of the user includes at least one or more facial expressions.

19. The terminal of claim 15, wherein the previously defined action of the user includes at least one or more body motion.

20. The terminal of claim 15, wherein the captured reproducing images indicate the contents and include header information including a capture time.

21. A terminal for providing additional information of contents, the terminal comprising:
a controller; and
one or more software modules configured for execution by the controller, the one or more modules including one or more instructions to:
connect to a contents server through the communication unit according to a corresponding input of the user, which is received from the input unit,
receive the contents, and
output the received contents as an image through the output unit and wherein the controller is configured to capture a reproducing image of the contents and a previously defined action of the user and transmit the captured reproducing image to the contents server through the communication unit when the previously defined action of the user is detected from a motion image of the user, which is received from the camera unit while outputting the captured reproducing image of the contents to the output unit.

22. The terminal of claim 21 further comprising:
an operation detecting sensor unit configured to sense motion of the user, wherein the instructions further includes to capture the reproducing image of the contents and the detected previously defined action of the user and transmit the captured reproducing images to a contents server when the previously defined action of the user is detected from information about the motion of the user, which is received from the operation detecting, sensor unit.

23. The terminal of claim 21, wherein the previously defined action of the user includes at least one or more facial expressions.

24. The terminal of claim 21, wherein the previously defined action of the user includes at least one or more body motion.

25. The terminal of claim 21, wherein the captured reproducing images indicate the contents and include header information including a capture time.
